(19) United States
(12) Patent Application Publication
(10) Pub. No.: US 2009/0318043 A1
(43) Pub. Date: Dec. 24, 2009

(54) METHOD FOR MAKING POLYMERIC EXTRUDED COMPOSITE PRODUCTS AND CARBON NANOTUBES

(75) Inventors: Thibault Vaugien, Gignac (FR); Kai Schierholz, Boucherville (CA)

Correspondence Address: FULBRIGHT & JAWORSKI L.L.P., 600 CONGRESS AVE., SUITE 2400, AUSTIN, TX, 78701, US

(73) Assignee: NANOLEDGE INC., Boucherville (CA)

(21) Appl. No.: 12/281,918

(22) PCT Filed: Mar. 5, 2007
(86) PCT No.: PCT/FR07/00387

§ 371 Date: Apr. 16, 2009

(30) Foreign Application Priority Data
Mar. 6, 2006 (FR) 0601982

(51) Int. Cl. B32B 5/02; B29C 47/88; D02G 3/02

(52) U.S. Cl. 442/60; 264/211.18; 428/367; 442/62

(57) ABSTRACT

The invention concerns a method for making polymeric extruded composite products and carbon nanotubes. Said method includes the following steps: a) performing an oxidation pretreatment of the carbon nanotubes; b) dispersing the nanotubes in a polymer solution; c) extruding the resulting dispersion into an intermediate product; d) drying said intermediate product; e) post-treating said dried intermediate product by hot drawing process; f) post-treating said dried intermediate product of said drawn intermediate product by drawing in an ionic solution; g) performing a formalizing treatment process: Steps e) f) and g) are optional. The extruded polymeric products obtained by the inventive method can contain up to 80 wt. % of nanotubes.

### FIELD OF THE INVENTION

The present invention relates to a process for manufacturing extruded composite products composed of a matrix or a polymer binder and for manufacturing carbon nanotubes.

The present invention also relates to extruded products obtained by said manufacturing process.

### STATE OF THE ART

The mechanical properties of carbon nanotubes (Young's modulus in the vicinity of 1000 GPa, tensile strength which can be as high as 150 GPa) make them potentially advantageous as reinforcements in composites (A. Krishnan, E. Dujardin, T. W. Ebessen, Phys. Rev. B. 58, 14 013 (1998)), particularly as charges in polymers. Likewise, the electrical and thermal conduction properties of these substances make them advantageous for certain applications (P. M. Ajayan, O. Zhou, Carbon Nanotubes: Synthesis, Structure, Properties and Applications, Springer-Verlag (2000)). However, the number of industrial products incorporating them is currently very limited.

The introduction of carbon nanotubes into polymer fibers makes it possible to improve certain characteristics of the fibers, in particular their electrical conductivity and certain mechanical properties (increase in rupture strength, increase in Young's modulus).

There are a number of known processes for manufacturing polymer/carbon nanotube composite fibers making it possible to manufacture different types of fibers.

Patent application US 2005/0100501 of Georgia Tech describes a process based on “wet spinning” technology for manufacturing polyacrylonitrile fibers reinforced with nanotubes. The quantity of carbon nanotubes in the fiber obtained is between 0.001 and 50 wt % nanotubes. The nanotubes used are single-wall nanotubes. The mechanical properties of the fibers obtained are quite superior to those of fibers made of pure polyacrylonitrile (increase in rupture strength, increase in Young's modulus); on the other hand, no indication is given as to the electrical properties of the fibers obtained by this process.

Patent application EP 1 574 551 of Teijin describes the use of the “wet spinning” process for manufacturing aromatic polyamide/carbon nanotube composite fibers. The maximum concentration of nanotubes in the fiber obtained is 50 wt %. It is indicated in the document that spinning becomes difficult at nanotube contents greater than 50 wt %.

Application PCT WO 00/69958 of Fina describes the manufacture of polymer fibers containing nanotubes by the “melt spinning” process. The polymers used as matrix/binder are preferably polyolefins, but they can also be polyamides, polyesters, PVC, polystyrene. The maximum concentration of nanotubes in the fibers obtained is 50 wt %. The electrical properties of the fibers obtained are not indicated. The mechanical properties are quite superior to those of fibers made of pure polymer (increase in rupture strength, increase in Young's modulus).

Patent application FR 2851260 relates to a device for manufacturing fibers and/or ribbons from particles put in suspension in a first solution and put in contact in a second solution with at least one agent capable of bringing about their aggregation. The device described in this patent application makes possible a continuous manufacturing of fibers from particles of the carbon nanotube type. This patent application however does not describe any process for obtaining fibers with a high content of carbon nanotubes.

Patent applications FR 2805179 and FR 2854409 of the CNRS (Poulin) relate to a process for obtaining fibers with a high content of colloidal particles (carbon nanotubes in particular), and to the fibers obtained by this process. The polymer preferably used for these fibers is PVA, and the spinning technique is “coagulation spinning.” The fibers obtained from spinning still contain surfactants. These surfactants can in certain cases have a detrimental influence on the properties of the polymer matrix. These fibers and the process for obtaining them are described in more detail in the following publications: “Macroscopic fibers and ribbons of oriented carbon nanotubes,” P, Poulin et al., 2000, Science, Vol. 290, p. 1331; “Improved structure and properties of single-wall carbon nanotubes spun fiber,” P. Poulin et al., Appl. Phys. Letter, 2002, Vo. 81, No. 5, p. 1.

Patent application US 2004/0096389 describes the spinning, working and applications of filaments, ribbons and strands of PVA charged with carbon nanotubes. The spinning is carried out using a “coagulation spinning” process similar to that used by Poulin. The nanotubes used in the process described in this patent application are necessarily single-wall nanotubes obtained by a process normally called the “HipCo process,” which are of small diameter and are purified.

The disadvantages of the processes mentioned above lie mainly in the limitation of the nanotube content of the fibers to 50 wt %. This limitation is due, on one hand, to the fact that it is very difficult to obtain a homogeneous dispersion of the nanotubes when their concentration becomes high, and on the other hand, to the fact that the spinning of solutions containing high concentrations of nanotubes is very difficult.

The homogeneity of the distribution of the nanotubes in the polymer matrix is a major concern. For example, it is known that the aggregates or agglomerates of nanotubes lead to a reduction of the mechanical strength of the fibers obtained. In practice, the difficulty in dispersing the nanotubes homogeneously in a matrix increases with the content of nanotubes. This is one of the reasons why the processes of the state of the art do not enable one to produce fibers with a very high content of nanotubes.

US 2005/0100501 already mentioned above proposes two approaches for preparing a dispersion with improved homogeneity of the nanotubes in the polymer: suspension of the nanotubes in a solvent followed by addition of the polymer, and simultaneous mixing of the nanotubes, the polymer and the solvent with vigorous stirring. This document also teaches the beneficial effect of a temperature increase on the homogeneity of the dispersion obtained.

### OBJECT OF THE INVENTION

The present invention relates to a process for manufacturing extruded polymer products containing carbon nanotubes and to the extruded products obtained by this process.

The present invention relates more particularly to manufacturing extruded products made of polymer containing nanotubes according to a process making it possible obtain products containing up to 80 wt % nanotubes.

### DESCRIPTION OF THE FIGURES

FIG. 1 represents an embodiment of the process according to the invention.

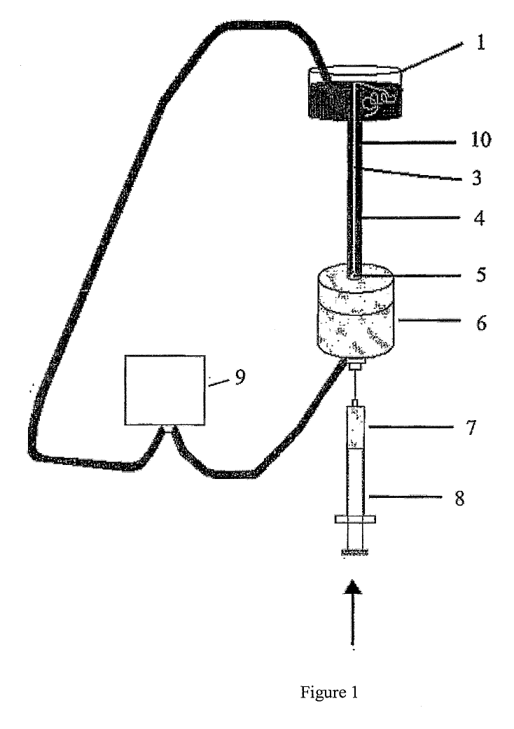

### DESCRIPTION OF THE INVENTION

According to the state of the art, the maximum percentage of nanotubes that extruded polymer/carbon nanotube products can contain is 50 wt %. This limitation is due mainly to the natural tendency of the carbon nanotubes to form aggregates when their concentration in a solution becomes too high.

The present invention solves this problem thanks to an original process for dispersing the carbon nanotubes in solutions of polymers, and thus proposes a novel process making it possible to obtain polymer/carbon nanotube composite fibers containing up to 80 wt % carbon nanotubes.

The present invention relates to a process for manufacturing extruded polymer products containing carbon nanotubes, said nanotubes being put in suspension in a first solution, said solution containing the nanotubes then being put in contact with a second solution containing at least one agent capable of bringing about the coagulation of the first solution or in contact with a solvent or with a mixture of solvents capable of bringing about the coagulation of the first solution. This process comprises the steps of:

a) Oxidation pretreatment of the carbon nanotubes by an oxidizing means;

b) Dispersing of the nanotubes in a polymer solution;

c) Extrusion of the dispersion thus obtained in the form of an intermediate product;

d) Drying of said intermediate product;

e) Post-treatment of said dried intermediate product by hot drawing;

f) Post-treatment of said dried intermediate product or of said drawn intermediate product in an ionic solution;

g) Formalization treatment: certain steps being optional, as will be explained hereafter.

A “carbon nanotube” can be defined as a graphite sheet wound and closed over itself, forming a hollow cylinder made up of carbon atoms. The carbon nanotubes used in the context of the present invention can be single-wall nanotubes consisting of a single cylinder or “multiwall” nanotubes consisting of a concentric pile of uniaxial cylinders. The terms “nanotube” or “CNT” will be used in this case as synonyms of the expression “carbon nanotubes.”

The nanotubes used in the present invention have a diameter between 0.7 and 50 nm, preferably between 0.7 and 30 nm and even more preferably between 0.7 and 25 nm, and preferably have a form factor (that is, the length/diameter ratio) of at least 100. These nanotubes can be produced by any method known to the expert in the field. The single-wall nanotubes used in the invention can be closed at each end by a wall made of carbon atoms which resembles a fullerene molecule; the multiwall nanotubes used in the invention can be closed or partially closed but are advantageously open at least one end.

The polymers which can be used in the process according to the invention are polyolefins and more particularly polyethylene (PE), as well as polyvinyl alcohol (PVA), polycarbonate (PC), polyvinyl chloride (PVC), polyterephthalates, polyamides, and in particular polyamides and in particular polyamide 6.6 (PA66), polyacrylonitrile (PAN).

“Extruded product” is understood to mean any product obtained by passage of a plastic solid, liquid or semiliquid product through a die or opening. For example, a fiber is an “extruded product.” “Fiber” is understood to mean a long product whose main characteristic is that it has an essentially constant cross section which can be of any shape, the dimensions of said cross section being small with respect to the length of the fiber.

The successive steps of the process according to the invention, certain ones being optional, are described hereafter.

### a) Oxidation Pretreatment of the Carbon Nanotubes

In the process according to the invention, this oxidation pretreatment step before the dispersing of the carbon nanotubes is a necessary step for subsequently obtaining a suitable dispersion of the nanotubes.

Oxidation of the CNTs can generate a variety of oxygenated functional groups such as carboxyl, alcohol, ester groups. These groups will be located on the structural defects on the surface of the nanotubes. The introduction of such groups is absolutely necessary in order to obtain a high percentage of nanotubes in the final extruded products.

The oxidation pretreatment of the nanotubes can be brought about by any appropriate oxidation means known to the expert in the field.

A preferred means is, for example, an oxidizing acid, a solution of potassium permanganate or bichromate, an oxygen plasma, ozone, etc.

The inventor observed that the multiwall nanotubes, which have more surface defects than the single-wall nanotubes, are easier to oxidize than the single-wall nanotubes.

In one embodiment of the present invention, the pretreatment of the CNTs is brought about by putting the nanotubes in an excess of nitric acid at a temperature between 20 and 150° C. at reflux for a duration between 30 min and 10 h.

In another embodiment of the present invention, the oxidation pretreatment of the nanotubes is brought about by putting the nanotubes in ozone created by an ozone generator, at a temperature between 15 and 35° C., for a duration between 45 min and 2 h.

The oxidation pretreatment using potassium permanganate can be brought about, for example, in the manner described in Hiura H., Ebbesen T. W., and Tanigaki K., Adv. Mater., 7, 275 (1995), or Colomer, J. F.; Piedigrosso, P.; Willems, I.; Joumet, C.; Bernier, P.; Tendeloo, G. V.; Fonseca, A.; B. Nagy, J. J. Chem. Soc., Faraday Trans. 1998, 94, 3753-3758.

### b) Dispersing of the Nanotubes

The dispersing of the nanotubes in an aqueous or organic solvent is a critical step in manufacturing extruded polymer/nanotube composite products. According to the state of the art, this dispersing is made particularly difficult by the natural tendency of the nanotubes to assemble in the form of aggregates, leading to a rather nonhomogeneous distribution, which is detrimental to the mechanical and electrical properties.

In the process according to the invention, the nanotubes are dispersed in a first polymer solution. In other words, and unlike what is conventionally done by the expert in the field, the polymer is put in solution before dispersing the nanotubes, which is favorable for obtaining a homogeneous CNT dispersion with a high CNT content in particular. In effect, the polymers used in the process according to the invention have an affinity for the surface groups created by the oxidation pretreatment, and/or an electrostatic affinity for the carbon nanotubes. By reducing the forces of attraction between CNTs, they prevent them from re-aggregating either by steric hindrance (particularly in media with a reasonably high dielectric constant) or by electrostatic interaction (generation of charges on the surface of the particles and formation of a diffuse cluster of ions of opposite charge, particularly in media with a low dielectric constant).

In one embodiment of the process according to the invention, the dispersing of the nanotubes obtained after the oxidation pretreatment step is brought about in three successive steps:

(b1) Putting a First Quantity of Polymer in Solution in a Solvent or Mixture of Solvents.

The solvent or mixture of solvents depends on the polymer used. Generally, the solvents that can be used in the process according to the invention are chosen from the group of solvents enabling dissolution of said polymer.

There is a method for predicting the solubility of a polymer in a solvent.

The comparison of the solubility parameters δ ([J/cm³)^{1/2}]) of the polymer and of the solvent give an indication as to the solubility of the polymer in the solvent.

δₛ is defined as the root of the cohesive energy density and can be determined/calculated based on the molar energy of vaporization of the solvent:

E_{S,m}=V_{S,m}δs², V_{S,m} being the molar volume of the solvent: V_{S,m}=N_{A}V_{S,m}.

In many cases, a polymer is soluble in a solvent if δs−δp=0 and is not soluble if δs−δp>0.

Said first quantity of polymer is chosen in such a way that the CNT/polymer weight ratio in the solution is between 5/1 and 15/1, so as to optimally reduce the re-aggregation of the CNTs in the dispersion.

In a particular embodiment of the process according to the invention, the polymer is PVA. In this case, the solvent can, for example, be water, DMSO, ethylene glycol, a polyol, ammonia, or else benzene sulfonamide, toluene sulfonamide, caprolactam, trimethylolpropane or their mixtures (water/urea, water/thiourea, DMSO/pentaerythritol), acetamide, DMF, formamide, glycerol, a glycol, HMTP, piperazine, triethylene, a diamine.

In another particular embodiment of the process according to the invention, the polymer is polycarbonate. In this case, the solvent can, for example, be THF, dioxane, methylene chloride, acetone, benzene, chloroform, toluene, cresol, cyclohexanone, ethyl acetate.

(b2) Addition of the Nanotubes Obtained after Pretreatment to this Solution,

(b3) Addition of a Second Quantity of Said Polymer to the Solution Coming from Step (b2),

Said second quantity of said polymer is chosen in such a way as to obtain the necessary CNT/polymer ratio for obtaining the desired CNT/polymer ratio in the final product.

For example, if one wishes to obtain a final extruded product having a nanotube content of 80%, and if 0.8 g of polymer has been introduced in step b1), and 8 g of CNTs have been introduced in step b2), it will be necessary to introduce 1.2 g of polymer in step b3).

In another embodiment of the process according to the invention, the dispersing is brought about in two successive steps:

(b1) Putting a Polymer in Solution in a Solvent.

The solvent or mixture of solvents depend on the polymer used. Generally, the solvents that can be used in the process according to the invention are chosen from the group of solvents enabling dissolution of said polymer.

In a particular embodiment of the process according to the invention, the polymer is PVA. In this case, the solvent can, for example, be water, DMSO, ethylene glycol, a polyol, ammonia, or else benzene sulfonamide, toluene sulfonamide, caprolactam, trimethylol propane or mixtures (water/urea, water/thiourea, DMSO/pentaerythritol), acetamide, DMF, formamide, glycerol, a glycol, HMTP, piperazine, triethylene, a diamine.

In another particular embodiment of the process according to the invention, the polymer is polycarbonate. In this case, the solvent can, for example, be THF, dioxane, methylene chloride, acetone, benzene, chloroform, toluene, cresol, cyclohexanone, ethyl acetate.

In a third particular embodiment of the process according to the invention, the polymer is a polyamide. In this case, the solvent can, for example, be sulfuric acid, trifluoroacetic acid, benzene acid, carbon tetrachloride, tetrahydrofuran, chloroform, dimethylformamide, DMA, DMSO, pyridine, 1,4-butanediol, dichloroacetic acid, 2-methyl-2,4-pentanediol, M-cresol, phenol, trifluoroethanol, formic acid, saturated saline solutions of an alcohol, the mixture chlorobenzene/trichloroacetic acid (1/1), dichloroacetic acid mixtures, the mixture formic acid/trichloroacetic acid (3/7), aqueous chloral hydrate, the aqueous solutions of CaBr₂ or FeCl₃, chloroacetic acid, cyanoacetic acid, formic acid, glycerol, nitric acid, nitrophenol, methylene chloride, alpha-pyrolidone, the aqueous solutions of Ca(CNS)₂, benzyl alcohol, O-chlorophenol, methanol, trifluoroacetamide, hexafluoroisopropanol, HMPT, acetone, the mixture 2,2,2-trifluoroethanol/methylene chloride (3/2), mesitylene/sulfolane, N-acetylmorpholine, 2-butene-1,4-diol, 1,3-chloropropanol, di(ethylene glycol), ethylene chlorhydrine, formamide, NMP, hexafluoropropanol, the mixture ethanol/water (4/1), ethyl acetate, DMF/LiCl mixtures, etc.

In a fourth embodiment of the process according to the invention, the polymer is PBT. In this case, the solvent can, for example, be P-chlorophenol/tetrachloroethane, trifluoroacetic acid, hexafluoroisopropanol (HFIP), chloroform, methylene chloride.

(b2) Addition of the Nanotubes Obtained after Pretreatment to this Solution.

The polymer can represent 20 to 100% of the substances introduced into the solvent so as to obtain final extruded products with CNT contents varying between 5 and 80 wt %.

### (c) Extrusion of the Dispersion

One then proceeds with the extrusion of the dispersion obtained after the second step.

The working by extrusion of the dispersion obtained in step (b) can be brought about in the following manner (see FIGURE): dispersion 7 is placed in reservoir 8, such as a syringe, which is connected to nozzle 6 (die or opening); then, dispersion 7 is injected through nozzle 6 into tube 4, the so-called coagulation tube, containing a solvent or mixture of solvents 10 (called coagulation solvent) capable of coagulating the polymer, or second solution 10 (called coagulation solution) containing a coagulation agent capable of coagulating the polymer. Any “non-solvents” of said polymer are capable of coagulating the polymer. “Non-solvent of a polymer” is understood to mean a solvent which does not enable said polymer to dissolve. In this case, the coagulation solvent and the coagulation solution are also called “coagulation bath” or “coagulant bath.”

Furthermore, the non-solvent must be miscible with the right thermodynamic solvent (namely the solvent used for dissolving the polymer in step (b)).

Generally, a given solvent does not mix with another solvent if the Gibbs energy of mixing is positive:

ΔGₘᵢₓ=ΔHₘᵢₓ−TΔSₘᵢₓ

On the other hand, a solvent is miscible with another solvent if the Gibbs energy of mixing is equal to zero or negative.

In one embodiment of the process according to the invention, the polymer is PVA. The coagulation solvent is chosen from carboxylic acids, halogenated hydrocarbons, esters, ketones, hydrocarbons, lower alcohols, concentrated saline solutions and THF.

In another embodiment of the process according to the invention, the polymer is polycarbonate. The coagulation solvent is chosen from ether, lower carboxylic chain alcohols (preferably C₁ to C₄ alcohols), water, carbon tetrachloride, acetone, styrene, lower esters.

In a third embodiment of the process according to the invention, the polymer is a polyamide. The coagulation solvent is chosen from alcohols, methanol, carbon disulfide, chloroform, HMPT, dilute bases, dilute acids, DMSO, DMF, formamide, diethyl ether, hydrocarbons, aliphatic ketones, aliphatic esters, hexane, ethanol/water mixture (4/1), glacial acetic acid, dioxane, THF.

In a fourth embodiment of the process according to the invention, the polymer is PBT. The coagulation solvent is chosen from apolar solvents (such as diethyl ether, carbon tetrachloride (CCl₄)) or weakly polar solvents, the term “apolar” designating an organic liquid which has a dielectric constant ε typically less than 9.5.

The coagulant bath is supplied by means of pump 9 making possible the circulation of the fluid in said coagulation tube and its return to the temperature-regulated bath.

In a preferred embodiment, said coagulation tube is supplied with a salt bath consisting of a supersaturated salt solution in motion, said dispersion forming a fiber under the action of the saline flow. The salt is advantageously chosen from sulfates, nitrates, chlorides, citrates, for example sodium sulfate, or potassium sulfate, or magnesium sulfate, or sodium nitrate, potassium chloride, disodium phosphate, or their mixtures, generally at a temperature such that the maximum solubility of the salt is reached and its coagulation power is maximized, for example, in the case of sodium sulfate, said temperature is 60° C.

For other embodiments, the temperature of the solution can be lowered or raised so as to promote toughness or a higher elongation percentage.

In another preferred embodiment, the dispersion is introduced into a syringe, which is then mounted on an assembly composed of a nozzle+syringe driver unit, attached above a coagulant bath composed of a solvent or mixture of solvents. The distance between the surface of the coagulant bath and the tip of the nozzle is on the order of 0.1 to 2 cm. The temperature of the coagulant bath is between −5° C. and 15° C. The flow rate of injection of the dispersion is a function of the viscosity of the dispersion (the higher the viscosity, the higher the flow rate has to be). When the dispersion is extruded through the nozzle, a drop or a strand forms at the end of the nozzle depending on the distance between the end of the nozzle and the surface of the coagulant bath. When the extruded product needs to be a fiber, the distance is set in such a way as to obtain a constant cross section when the fiber enters the coagulant. The fiber forms and keeps its structure under the effect of the solvent exchange which occurs in contact with the bath. In the case in which the product is extruded in the form of drops, the drops can be collected in order to form granules (pellets).

### (d) Drying of the Extruded Product

Drying of the obtained extruded product can be carried out by any means known to the expert in the field.

Drying of the fiber can be carried out, for example, by passage of said fiber under infrared lamps.

Drying of the product can also be carried out by passage in a hot air current.

### (e) Post-Treatment by Hot Drawing

When the dried extruded products are fibers, they optionally undergo a post-treatment consisting of hot drawing, at temperatures between the glass transition temperature of the polymer and a temperature 50° C. lower than the glass transition temperature of the polymer, and with drawing percentages between 0 and 800%.

In a preferred embodiment, the temperature chosen for the drawing is between the glass transition temperature of the polymer and a temperature 25° C. lower than the glass transition temperature of the polymer.

In a more preferred embodiment, the temperature chosen for the drawing is between the temperature of glass transition of the polymer and a temperature 10° C. lower than the glass transition temperature of the polymer.

### (f) Post-Treatment by Drawing in an Ionic Solution

When the extruded products obtained are fibers, after extrusion or after hot drawing, they optionally undergo a post-treatment of drawing in an ionic solution, preferably in a supersaturated solution of a suitable coagulant agent. Even more preferably, a supersaturated solution of sodium sulfate is used.

### (g) Formalization Treatment

When the extruded products obtained are fibers, after spinning and drying, hot drawing or drawing in solution, they can be placed in a bath containing a salt, formaldehyde and a strong acid or else in a bath of boiling silicone oil.

This treatment, in this case called formalization treatment for the two variants (i.e. the variant with formaldehyde and the variant with silicone oil), has the effect of increasing the toughness of the fibers, their elastic recovery, and their ability to take up dye.

The present invention also relates to the extruded products that can be obtained by the process described above.

Advantageously, the present invention makes it possible to produce extruded products, and particularly fibers and granules, based on PVA, PC, PA and more particularly PA 6-6, PAN, polyterephthalates, polyolefins, and particularly PE, PVC. More particularly, it makes it possible to produce extruded products which are inaccessible with the known processes. In particular, it is possible to incorporate a concentration of CNT with respect to the final extruded product that is greater than 50% and which can be as much as 80%.

As an example, it is possible to produce extruded products:
Made of PVA with a CNT content greater than 30% and more particularly greater than 40%. These products do not contain any trace of surfactant.
Made of polycarbonate with a CNT content between 5 and 80%.
Made of PAN with a CNT content greater than 50% and preferably greater than 60%.
Made of polyolefins with a CNT content greater than 50% and preferably greater than 60%.
Made of polyamide with a CNT content greater than 50% and preferably greater than 60%.

The process according to the invention with its different variants makes it possible to obtain fibers with properties which can be varied within a considerable range.

As an example, it is possible to manufacture extruded PVA products whose electrical resistivity varies from approximately 10⁻² to 10² ohm·cm. This makes it possible to adapt the electrical conductivity for a given product to the intended application. These extruded products can be used for manufacturing antistatic fabrics or devices such as lacquers and varnishes with controlled conductivity or electrically conductive fabrics or devices or fabrics or devices with dissipative electrical properties.

They can be composite fibers or products made from master batches incorporating fibers, chopped fibers or granules.

The extruded products obtained by the process according to the invention can be used for the manufacturing of rope or in construction materials.

The process according to the invention will be better understood thanks to the examples disclosed hereafter which however do not limit the scope of the invention.

### Example 1

### PVA Fiber with Antistatic Properties

1.25 g of carbon nanotubes was mixed with 5 g of PVA dissolved in 200 mL of DMSO. This dissolution was carried out at a temperature of 100° C. and in such a way as to avoid evaporation (reflux).

The mixture was then treated by ultrasound using a Branson brand apparatus until a homogeneous dispersion was obtained.

Then, the mixture was put in the reservoir bath of an extrusion machine and pumped through a spinneret into a coagulant bath composed of a mixture composed of 50% toluene and 50% acetone.

The flow rate of the syringe driver was set to 22 mL/min.

The tip of the syringe was slid into a nozzle with a diameter of 0.4 mm.

This nozzle was approximately 0.2 cm from the surface of the coagulant bath.

When the liquid entered the coagulant bath, a fiber formed, which was subsequently wound. Then, the fiber was drawn and dried by a current of hot air with a temperature of 130° C.

The coiling and drawing device entailed a number of rollers, certain ones assigned to drawing and the last assigned to winding. Between these rollers were drying and drawing devices (hot air, radiation) and guides.

The resistivity obtained for this fiber type was approximately 1 ohm·cm, which makes it suitable mainly for antistatic applications.

The mechanical characteristics obtained for this fiber type were:

Young's modulus: 14.4 GPa

Elongation at break: 8.5%

Rupture stress: 496 MPa

These fibers can be used for manufacturing devices or fabrics with antistatic properties.

### Example 2

### PVA Fiber with Dissipative Properties

0.5 g of carbon nanotubes was mixed with 5 g of PVA dissolved in 200 mL of DMSO. This dissolution is carried out at 100° C. and in such a way as to avoid evaporation (reflux).

The process was then identical to that described for Example 1.

The resistivity obtained for this fiber type was on the order of 10 ohm·cm, which makes it suitable mainly for dissipative applications. The mechanical characteristics obtained for this fiber type were:

Young's modulus: 12.76 GPa

Elongation at break: 13%

Rupture stress: 704 MPa

These fibers can be used for manufacturing devices or fabrics with dissipative properties.

### Example 3

### PVA Fiber with Conductive Properties

2 g of carbon nanotubes were mixed with 2 g of PVA dissolved in 200 mL of DMSO. This dissolution is carried out at 100° C. and in such a way as to avoid evaporation (reflux).

The process was then identical to that described for Example 1.

The resistivity obtained for this fiber type was approximately 10⁻¹ ohm·cm which makes it suitable mainly for applications in which conductivity must be combined with great flexibility of the fiber.

The mechanical characteristics obtained for this fiber type were:

Young's modulus: 3.15 GPa

Elongation at break: 14%

Rupture stress: 128 MPa

These fibers can be used for manufacturing conductive devices or fabrics.

### Example 4

### PVA Fiber with Antistatic Properties

1.25 g of carbon nanotubes was mixed with 1 g of PVA dissolved in 200 mL of distilled water. This dissolution is carried out at 100° C. and in such a way as to avoid evaporation (reflux).

The mixture was then treated by ultrasound using a Branson brand apparatus until a homogeneous dispersion was obtained.

Another 4 g of PVA were added and dissolved in the same manner as in the preceding.

A coagulant bath was prepared by bringing distilled water to 60° C. and dissolving sodium sulfate until a saturated solution was obtained.

Then, the mixture was put in the reservoir bath of an extrusion machine and pumped through a spinneret into a coagulant bath as described above.

The flow rate of the syringe driver was set to 22 mL/min, and the flow rate of the saline flow was set to 200 mL/min.

The tip of the syringe was slid into a nozzle with a diameter of 0.4 mm.

When the liquid entered the coagulant bath, a fiber formed, which was subsequently wound.

In the next step, the fiber was rinsed, drawn and dried by a current of hot air with a temperature of 130° C.

The winding and drawing device entailed a number of rollers, certain ones assigned to drawing and the last assigned to coiling. Between these rollers were drying and drawing devices (hot air, radiation) and guides.

The resistivity obtained for this fiber type was approximately 2 ohm·cm which makes it suitably for mainly antistatic applications.

### Example 5

### PC Fiber with Conductive Properties

3.2 g of carbon nanotubes were mixed with 2 g of PC dissolved in 200 mL of THF. This dissolution was carried out at 100° C. and in such a way as to avoid evaporation (reflux). The CNTs were added in 0.2 g portions in conjunction with 0.2 g of dispersing agent consisting of a dispersing polymer from the company Noveon Solsperse (32600).

The mixture was then treated by ultrasound using a Branson brand apparatus until a homogeneous dispersion was obtained.

Then, the mixture was put in the reservoir bath of an extrusion machine and pumped through a “spinneret” into a coagulant bath composed of methanol.

The flow rate of the syringe driver was set to 22 mL/min.

The tip of the syringe was slid into a nozzle with a diameter of 0.4 mm.

This nozzle was approximately 0.2 cm from the surface of the coagulant bath.

When the liquid entered the coagulant bath, a fiber formed, which was subsequently wound.

In the next step, the fiber was drawn and dried by a current of hot air with a temperature of 130° C. The winding and drawing device entailed a number of rollers, certain ones assigned to drawing and the last assigned to coiling. Between these rollers were drying and drawing devices (hot air, radiation) and guides.

The resistivity obtained for this type of fiber was approximately 10⁻² ohm·cm, which makes it suitable mainly for conductive applications.

These fibers can be used for manufacturing conductive devices or fabrics.

### Example 6

### PC Fiber with Dissipative Properties

0.4 g of carbon nanotubes was mixed with 4 g of PC dissolved in 200 mL of THF. This dissolution was carried out at 100° C. and in such a way as to avoid evaporation (reflux). The CNTs were added in 0.2 g portions in conjunction with 0.2 g of dispersing agent consisting of a dispersing polymer from the company Noveon Solsperse (32600).

The process was then identical to that of Example 4.

The resistivity obtained for this fiber type was approximately 18.5 ohm·cm, which makes it suitable for applications in the field of antistatic or charge dissipation.

1. A process for manufacturing extruded polymer products containing carbon nanotubes, said nanotubes being put in suspension in a first solution, said solution containing the nanotubes then being put in contact with a second solution containing an agent capable of bringing about the coagulation of the first solution or in contact with a solvent or with a mixture of solvents capable of bringing about the coagulation of the first solution, said process comprising the steps of:
a) Oxidation pretreatment of the carbon nanotubes by an oxidizing means;
b) Dispersing of the nanotubes obtained in step a) in a first polymer solution;
c) Working by extrusion of dispersion (7) thus obtained in step b), said dispersion being placed in reservoir (8), such as a syringe, connected with nozzle (6), and then being injected by said nozzle into tube (4), the so-called coagulation tube, containing a coagulant bath consisting of said solvent or mixture of solvents (10) capable of coagulating the polymer, or said second solution (10) containing a coagulation agent capable of coagulating the polymer,
d) Drying of the extruded product obtained in step c);
e) Optionally, post-treatment of said extruded product obtained in the form of a fiber in step d) by hot drawing, at a temperature between the temperature of glass transition of the polymer and a temperature 50° C. lower than the temperature of glass transition of the polymer;
f) Optionally, post-treatment of said extruded product obtained in the form of a fiber in step d) or e) by drawing in an ionic solution;
g) Optionally, formalization treatment of said extruded product obtained in the form of a fiber in step d), e) or f).

2. Process according to claim 1, characterized by the fact that step b) comprises:
b1) Putting the polymer in solution in a solvent or a mixture of solvents,
b2) Dispersing of the nanotubes obtained in step a) in said polymer solution.

3. Process according to claim 2, characterized by the fact that step b) moreover comprises, after the addition of a first quantity of polymer in step b1) followed by step b2):
b3) The addition of a second quantity of polymer in said dispersion.

4. Process according to any one of claims 1 to 3, characterized by the fact that optional step f) consists of drawing of the product obtained in step d) or e) in a supersaturated solution of an appropriate coagulation agent.

5. Process according to claim 4, characterized by the fact that the coagulation agent used in step f) is sodium sulfate.

6. Process according to any one of claims 1 to 5, characterized by the fact that optional step g) consists of a formalization treatment of the fiber obtained in step d), e) or f) in a bath containing a salt, formaldehyde and a strong acid or else in a bath of boiling silicone oil.

7. Process according to any one of claims 1 to 6, characterized by the fact that in step c), said coagulation tube contains a salt bath consisting of a supersaturated salt solution, in such a way that said dispersion solidifies under the action of the saline flow and forms a fiber.

8. Process according to claim 7, characterized by the fact that in step c), the salt is chosen from the group consisting of the sulfates, nitrates, chlorides, citrates, sodium sulfate, potassium sulfate, magnesium sulfate, sodium nitrate, potassium chloride, disodium phosphate, and their mixtures.

9. Process according to any one of claims 1 to 6, characterized by the fact that in step c), said dispersion is introduced into a syringe and injected into said coagulant bath composed of a solvent or mixture of solvents.

10. Process according to claim 9, characterized by the fact that the solvent is chosen from the group consisting of solvents which do not enable dissolution of said polymer.

11. Process according to any one of claims 1 to 10, characterized by the fact that in step a), the drawing percentage is between 0 and 800%.

12. Process according to claim 1, characterized by the fact that said polymer is chosen from the group consisting of polyolefins, PVA, PC, polyterephthalates, polyamides, PAN.

13. An extruded product which can be obtained by the process of any one of claims 1 to 12, characterized by the fact that said polymer is PVA.

14. Extruded product according to claim 13, characterized by the fact that the percentage of nanotubes varies from 30 to 80 wt %.

15. An extruded product which can be obtained by the process of any one of claims 1 to 12, characterized by the fact that said polymer is chosen from PAN and polyolefins.

16. Extruded product according to claim 15, characterized by the fact that the percentage of nanotubes varies from 50 to 80 wt %.

17. An extruded product which can be obtained by the process of any one of claims 1 to 12, characterized by the fact that said polymer is chosen from polyamides, polycarbonate and polyterephthalates.

18. Extruded product according to claim 17, characterized by the fact that the percentage of nanotubes varies from 5 to 80 wt %.

19. Use of the extruded product according to any one of claims 13 to 18 for manufacturing antistatic fabrics or devices.

20. Use of the extruded product according to any one of claims 13 to 18 for manufacturing electrically conductive fabrics or devices.

21. Use of the extruded product according to any one of claims 13 to 18 for manufacturing dissipative fabrics or devices.

22. Use of the extruded product according to any one of claims 13 to 18 in construction materials.

23. Use of the extruded product according to any one of claims 13 to 18 for manufacturing rope.
